(19) United States
(12) Patent Application Publication
(10) Pub. No.: US 2009/0222764 A1
(43) Pub. Date: Sep. 3, 2009

(54) INFORMATION PROCESSING DEVICE, INFORMATION DISPLAY METHOD, AND COMPUTER PROGRAM

(76) Inventors: Takeshi KANDA, Tokyo (JP); Kazuaki TAGUCHI, Kanagawa (JP)

Correspondence Address: FROMMER LAWRENCE & HAUG LLP, 745 FIFTH AVENUE, NEW YORK, NY, 10151, US

(21) Appl. No.: 12/393,073

(22) Filed: Feb. 26, 2009

(30) Foreign Application Priority Data
Feb. 29, 2008 (JP) P2008-049516

(51) Int. Cl. G06F 3/048

(52) U.S. Cl. 715/810

(57) ABSTRACT

An information processing device includes a screen display control portion, an icon display control portion, and an icon moving portion. The screen display control portion controls a display of an area on a screen such that the area is able to accept an input operation by a user based on a display of an object on the screen and an operation signal that corresponds to the input operation by the user and that designates the area. The icon display control portion displays an icon that corresponds to the object that is displayed on the screen. The icon moving portion moves the icon dynamically, based on the operation signal, to a target position within the area that is designated by the operation signal.

### CROSS REFERENCES TO RELATED APPLICATIONS

The present invention contains subjected matter related to Japanese Patent Application JP 2008-49516 filed in the Japan Patent Office on Feb. 29, 2008, the entire contents of which being incorporated herein by reference.

### BACKGROUND OF THE INVENTION

1. Field of the Invention

The present invention relates to an information processing device, an information display method, and a computer program. More specifically, the present invention relates to an information processing device, an information display method, and a computer program that display icons on a screen and perform various types of processing.

2. Description of the Related Art

Numerous information processing devices exist that are configured such that they display a plurality of information items on a screen and allow a user to perform various types of processing rapidly by referring to the displayed plurality of information items. One example of such an information processing device is a video editing system such as that described in Japanese Patent No. 3775611. The video editing system is required to provide rapid editing processing, and it meets the requirement by displaying a plurality of information items on a screen.

The editing system that is described in Japanese Patent No. 3775611 has such functions as displaying a thumbnail of a video that the user wants to edit on the screen and displaying a timeline that allows the user to recognize the playback position of the video. The user of the editing system can edit videos quickly by referring to the displayed plurality of information items.

A known video editing system, as shown in FIG. 10, for example, displays a screen that includes a main screen 11 and sub-screens 12a, 12b, 12c, and 12d that are displayed as overlays on the main screen 11. The main screen 11 is used to display videos that can be edited and videos that have been edited. The sub-screens 12a, 12b, 12c, and 12d are screens that each provides a different function. For example, the sub-screen 12a is a screen for displaying thumbnails of the videos that can be edited and designating a video to be edited. The sub-screen 12b is a screen for displaying a state (a playback time, a playback position, or the like) of a video that is designated on the sub-screen 12a. The sub-screen 12c is a screen for displaying thumbnails of videos that have been edited and designating an edited video. The sub-screen 12d is a screen on which various types of buttons and the like for performing editing operations are arrayed.

On the screen that is shown in FIG. 10, the sub-screens 12a, 12b, 12c, and 12d are switched between displayed and non-displayed states by operating commands from the user, and a state in which all of the sub-screens are displayed can be achieved. Moreover, even in a case where a plurality of the sub-screens are displayed, only one of the sub-screens is actually enabled such that it can accept an operating command from the user.

### SUMMARY OF THE INVENTION

The known technologies, in order to distinguish which one of the sub-screens is able to accept an operating command from the user on a screen like that shown in FIG. 10, use such methods as displaying a frame around the operable sub-screen and lowering the brightness of the other sub-screens while displaying the operable sub-screen relatively brightly. However, the known technologies have a problem in that they switch the displays instantaneously, and in a case where a plurality of the sub-screens is displayed, it is difficult for the user to discern by a single glance at the screen which of the sub-screens is the enabled (activated) sub-screen.

Accordingly, the present invention addresses this problem and provides an information processing device, an information display method, and a computer program that are new and improved and that are capable of changing the enabled screen in response to an operation input from the user and making it easy to distinguish the screen that is enabled to accept the operation input from the user.

According to an embodiment of the present invention, there is provided an information processing device that includes a screen display control portion, an icon display control portion, and an icon moving portion. The screen display control portion controls a display of an area on a screen such that the area is able to accept an input operation by a user based on a display of an object on the screen and an operation signal that corresponds to the input operation by the user and that designates the area. The icon display control portion displays an icon that corresponds to the object that is displayed on the screen. The icon moving portion moves the icon dynamically, based on the operation signal, to a target position within the area that is designated by the operation signal.

In this configuration, the screen display control portion controls the display of the area on the screen such that the area is able to accept the input operation by the user based on the display of the object on the screen and the operation signal that corresponds to the input operation by the user and that designates the area. Further, the icon display control portion displays the icon that corresponds to the object that is displayed on the screen, and the icon moving portion moves the icon dynamically, based on the operation signal, to the target position within the area that is designated by the operation signal. Using the icon moving portion to take the icon that is displayed by the icon display control portion and dynamically move it to the screen that is enabled to accept the operation input from the user, with the enabled screen being changed according to the operation input from the user, makes it easy to determine which screen is enabled to accept the operation input from the user.

A user interface portion may also be provided that, in accordance with the user input operation that corresponds to the icon, generates the operation signal such that the operation signal directly designates the object that corresponds to the designated icon.

The number of the icons that is displayed by the icon display control portion is more than one, and the icon moving portion may also cause all of the plurality of the icons displayed by the icon display control portion to arrive at the target position at the same time.

The number of the icons that is displayed by the icon display control portion is more than one, and the icon moving portion may also move the icons displayed by the icon display control portion such that they arrive at the target position at different times.

The icon moving portion may also perform control such that the speed at which the icon that is displayed by the icon display control portion moves becomes slower to the extent that it moves closer to the target position. The icon moving portion may also move the icon that is displayed by the icon display control portion to the target position in a straight line.

A numeral may also be associated with the icon. This makes it possible for the user to press a button to which a numeral is assigned, such as a button on a ten-key pad that is provided on a keyboard or the like that is connected to the information processing device, in order to perform an operation on an object that corresponds to the numeral button that the user presses.

Based on the operation signal, the screen display control portion may also switch the area that is able to accept the input operation by the user and may switch the display accordingly. The icon moving portion may also move the icon dynamically to a target position within the area that the screen display control portion has made able to accept the input operation by the user. The switching of the display of the area that is enabled to accept the input operation by the user, and the dynamic moving of the icon, make it easy to distinguish the screen that is enabled to accept the operation input from the user.

According to another embodiment of the present invention, there is provided an information display method that includes a step of controlling a display of an area on a screen such that the area is able to accept an input operation by a user based on a display of an object on the screen and an operation signal that corresponds to the input operation by the user and that designates the area. The information display method also includes a step of displaying an icon that corresponds to the object that is displayed on the screen. The information display method also includes a step of moving the icon dynamically, based on the operation signal, to a target position within the area that is designated by the operation signal.

In this configuration, one of the steps controls the display of the area on the screen such that the area is able to accept the input operation by the user based on the display of the object on the screen and the operation signal that corresponds to the input operation by the user and that designates the area. Another of the steps displays the icon that corresponds to the object that is displayed on the screen. Another of the steps moves the icon dynamically, based on the operation signal, to the target position within the area that is designated by the operation signal. The dynamic moving of the displayed icon to the screen that is enabled to accept the operation input from the user, with the enabled screen being changed according to the operation input from the user, makes it easy to determine which screen is enabled to accept the operation input from the user.

According to another embodiment of the present invention, there is provided a computer program that causes a computer to perform a step of controlling a display of an area on a screen such that the area is able to accept an input operation by a user based on a display of an object on the screen and an operation signal that corresponds to the input operation by the user and that designates the area. The computer program also causes the computer to perform a step of displaying an icon that corresponds to the object that is displayed on the screen. The computer program also causes the computer to perform a step of moving the icon dynamically, based on the operation signal, to a target position within the area that is designated by the operation signal.

In this configuration, one of the steps controls the display of the area on the screen such that the area is able to accept the input operation by the user based on the display of the object on the screen and the operation signal that corresponds to the input operation by the user and that designates the area. Another of the steps displays the icon that corresponds to the object that is displayed on the screen. Another of the steps moves the icon dynamically, based on the operation signal, to the target position within the area that is designated by the operation signal. The dynamic moving of the displayed icon to the screen that is enabled to accept the operation input from the user, with the enabled screen being changed according to the operation input from the user, makes it easy to determine which screen is enabled to accept the operation input from the user.

According to the present invention as described above, an information processing device, an information display method, and a computer program can be provided that display on the screen the icon that corresponds to the object that is displayed on the screen and dynamically move the icon according to the operation input from the user, making it possible to change the enabled screen according to the operation input from the user and making it easy to determine which screen is enabled to accept the operation input from the user.

### BRIEF DESCRIPTION OF THE DRAWINGS

FIG. 1 is an explanatory figure that explains an overview of a video editing system 10 according to an embodiment of the present invention;

FIG. 2 is an explanatory figure that explains an external appearance of a controller 153 according to the embodiment of the present invention;

FIG. 3 is an explanatory figure that explains a hardware configuration of an information processing device 100 according to the embodiment of the present invention;

FIG. 4 is an explanatory figure that explains a screen that is displayed on a display device 160 in the video editing system 10 according to the embodiment of the present invention;

FIG. 5 is a flowchart that explains an information display method according to the embodiment of the present invention;

FIG. 6A is an explanatory figure that explains a screen that is displayed on the display device 160;

FIG. 6B is an explanatory figure that explains a screen that is displayed on the display device 160;

FIG. 6C is an explanatory figure that explains a screen that is displayed on the display device 160;

FIG. 6D is an explanatory figure that explains a screen that is displayed on the display device 160;

FIG. 7A is an explanatory figure that explains a screen that is displayed on the display device 160;

FIG. 7B is an explanatory figure that explains a screen that is displayed on the display device 160;

FIG. 7C is an explanatory figure that explains a screen that is displayed on the display device 160;

FIG. 8A is an explanatory figure that explains a screen that is displayed on the display device 160;

FIG. 8B is an explanatory figure that explains a screen that is displayed on the display device 160;

FIG. 8C is an explanatory figure that explains a screen that is displayed on the display device 160;

FIG. 9A is an explanatory figure that explains a screen that is displayed on the display device 160;

FIG. 9B is an explanatory figure that explains a screen that is displayed on the display device 160;

FIG. 9C is an explanatory figure that explains a screen that is displayed on the display device 160;

FIG. 10 is an explanatory figure that shows a screen that is displayed in a known video editing system;

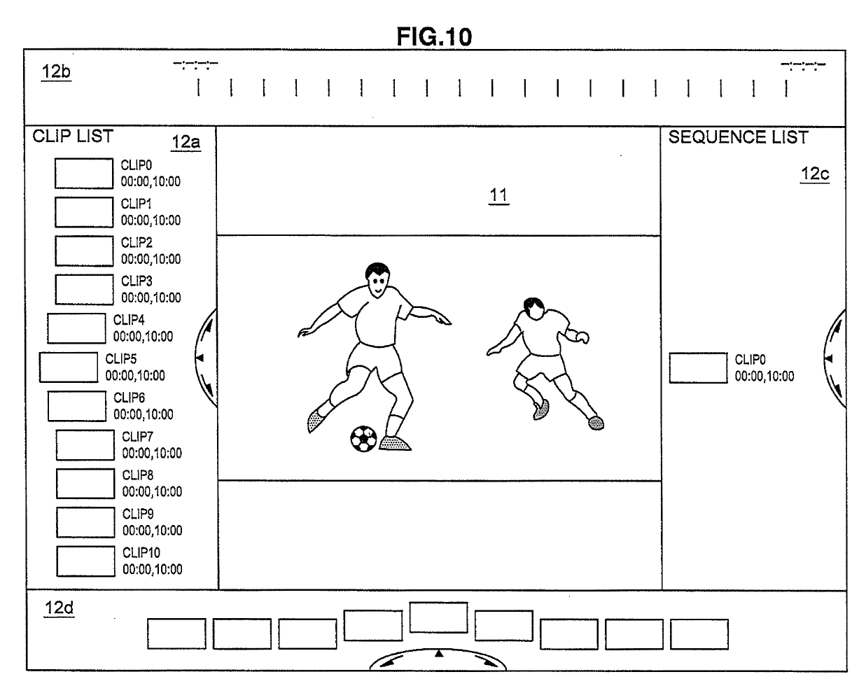

FIG. 11 is an explanatory figure that explains a modified example of the video editing system according to the embodiment of the present invention; and

FIG. 12 is an explanatory figure that explains a hardware configuration of a controller 153a that is used in the modified example of the video editing system according to the embodiment of the present invention.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

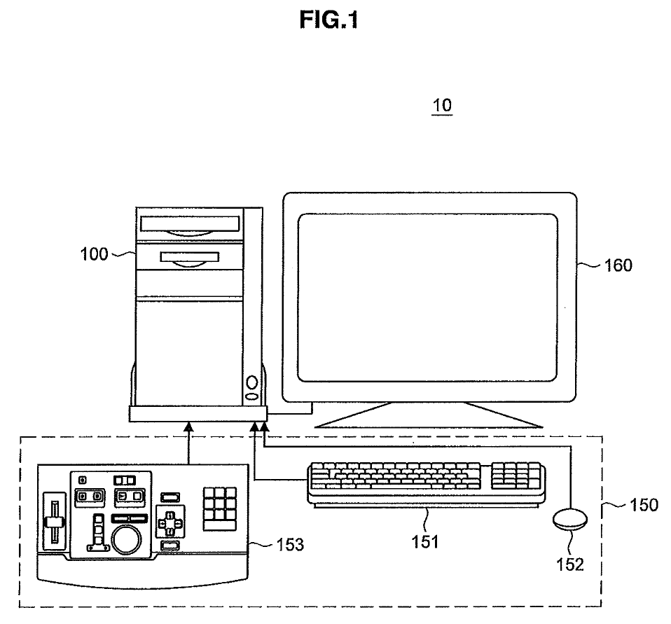

First, a video editing system according to an embodiment of the present invention will be explained. FIG. 1 is an explanatory figure that explains an overview of a video editing system 10 according to the embodiment of the present invention. The video editing system 10 will be explained below using FIG. 1.

The video editing system 10 performs editing of video data by cutting images and splicing a plurality of images. The video editing system 10 is configured such that it includes an information processing device 100, an input unit 150, and a display device 160.

The information processing device 100 houses an internal video editing function and performs video data editing processing by cutting images, splicing a plurality of images, and the like. The editing processing can be performed by a user's operating of the input unit 150.

The input unit 150 is configured from a keyboard 151, a mouse 152, a controller 153, and the like. By using the input unit 150, the user can perform the video editing processing, such as cutting an image, splicing images, superimposing subtitles, and the like.

The display device 160 displays the video data before it is edited and the video data after it has been edited by the information processing device 100. The display device 160 also displays a screen, using a graphical user interface (GUI) that also provides a function for performing the editing of the video data. The screen that is displayed on the display device 160 by the GUI makes it possible for the user to perform editing operations intuitively.

An overview of the operation of the video editing system 10 will be explained briefly below. Video signals for images that are captured by a video camera or the like are input to a recorder (not shown in the drawing) and sequentially recorded. The user of the video editing system 10 performs the editing of the video data by operating the various input devices of the input unit 150 that is connected to the information processing device 100 while looking at the video data that is displayed on the display device 160.

When the user edits the video data, the user's operating of the various input devices of the input unit 150 with respect to the screen that is displayed on the display device 160 by the GUI causes control commands for editing to be generated in the information processing device 100. For example, if the user operates the various input devices of the input unit 150 to designate an editing start point (an in point) and an editing end point (an out point), a control command is generated such that only the video data from the in point to the out point is output. The control commands that are generated by the information processing device 100 are sent to the recorder in which the video signals are recorded, and the edited video signals are output from the recorder to an external destination.

The overview of the video editing system 10 according to the embodiment of the present invention has been explained using FIG. 1. Next, the controller 153 according to the embodiment of the present invention will be explained.

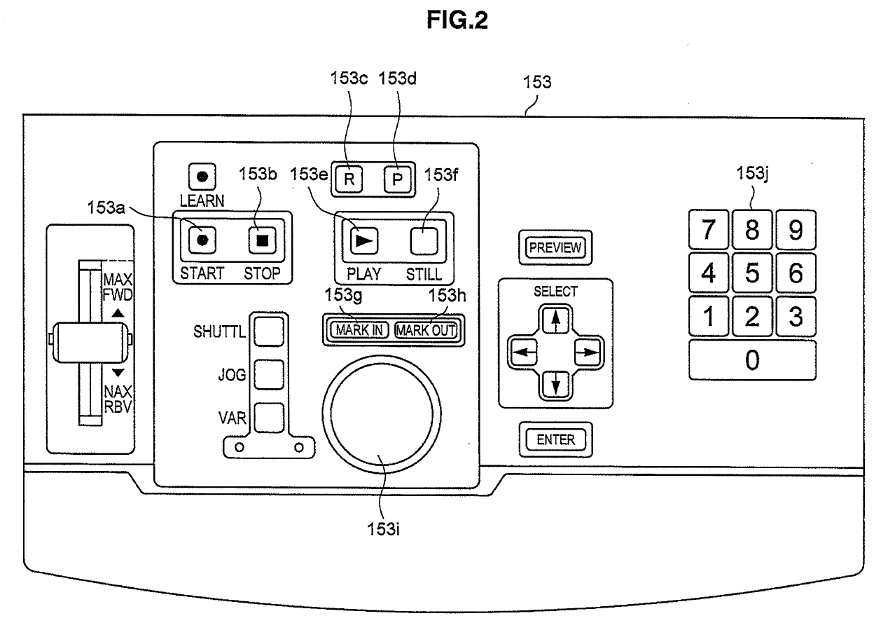

FIG. 2 is an explanatory figure that explains an external appearance of the controller 153 according to the embodiment of the present invention. The external appearance of the controller 153 according to the embodiment of the present invention will be explained below using FIG. 2.

The user of the video editing system 10 uses the controller 153 to perform the work of editing the video data. Buttons and keys are arranged on the controller 153 such that the user can perform the work of editing the video data quickly. As shown in FIG. 2, the controller 153 according to the embodiment of the present invention is configured such that it includes a Start button 153a, a Stop button 153b, a recording selection button 153c, a playback selection button 153d, a Play button 153e, a Still button 153f, a Mark In button 153g, a Mark Out button 153h, a jogging dial 153i, and a ten-key pad 153j.

The Start button 153a is a button that the user presses to take the video data that is being edited on the information processing device 100 and record it in the recorder or the like. When the user presses the Start button 153a, a recording start command is output from the information processing device 100 that causes the video data for which the editing work is being performed on the information processing device 100 to be recorded in the recorder. The Stop button 153b is a button that the user presses to stop the operation of recording in the recorder the video data that is being edited. When the user presses the Stop button 153b, a recording stop command is output from the information processing device 100 that stops the recording operation in the recorder.

The recording selection button 153c is a button that the user presses to select an edited video to be worked on using the controller 153. By pressing the recording selection button 153c, the user enables an operation that selects video data that has been edited by the video editing system 10. The playback selection button 153d is a button that the user presses to select an unedited video to be worked on using the controller 153. By pressing the playback selection button 153d, the user enables an operation that selects video data that has been recorded in the recorder or the like before the video data is edited by the video editing system 10.

The Play button 153e is a button that the user presses to play back the video data. When the user presses the Play button 153e, a playback start command is output from the information processing device 100 to the recorder or the like that causes the video data that the user has selected to be played back and displayed on the display device 160. The Still button 153f is a button that the user presses to halt the video data that is being played back. When the user presses the Still button 153f, a playback halt command is output from the information processing device 100 to the recorder or the like that halts the playback operation for the video data that is being displayed on the display device 160.

The Mark In button 153g is a button that the user presses to designate the editing start point (the in point) in the video data that is to be edited. The Mark Out button 153h is a button that the user presses to designate the editing end point (the out point) in the video data that is to be edited. By pressing the Mark In button 153g and the Mark Out button 153h, the user can designate the range of the video data that is to be edited.

The jogging dial 153i is a rotary encoder that the user operates to select the video data to be played back and to change the playback speed of the video data that is being played back. To select the video data to be played back, the user presses one of the recording selection buttons 153c and the playback selection button 153d to enable the video data selection operation, then operates the jogging dial 153i to select the video data. To change the playback speed of the video data that is being played back, the user presses the Play button 153e to play back the video data, and then operates the jogging dial 153i to change the playback speed.

The ten-key pad 153j has keys that are numbered from 0 to 9. The use can input a number by pressing any one of the keys in the ten-key pad 153j. In the present embodiment, the user can use the ten-key pad 153j to directly select the video data to be played back on the screen that is displayed on the display device 160 by the GUI and to designate the playback position of the video data. A detailed description of the screen that is displayed on the display device 160 by the GUI in the present embodiment will be provided later.

The external appearance of the controller 153 according to the embodiment of the present invention has been explained using FIG. 2. Next, a hardware configuration of the information processing device 100 according to the embodiment of the present invention will be explained.

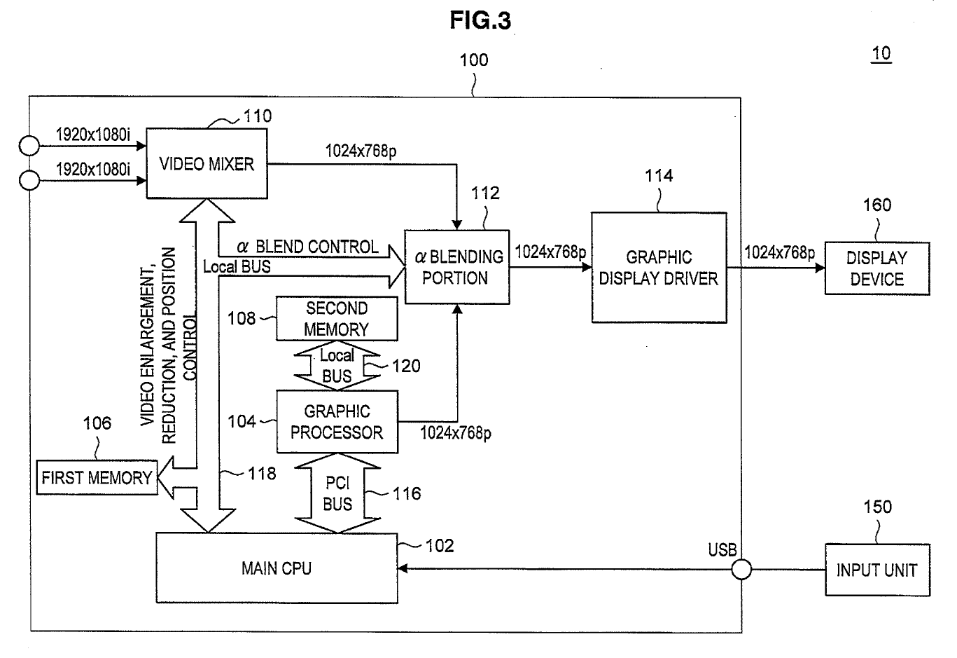

FIG. 3 is an explanatory figure that explains the hardware configuration of the information processing device 100 according to the embodiment of the present invention. The hardware configuration of the information processing device 100 according to the embodiment of the present invention will be explained below using FIG. 3.

As shown in FIG. 3, the information processing device 100 according to the embodiment of the present invention is configured such that it includes a main central processing unit (CPU) 102, a graphic processor 104, a first memory 106, a second memory 108, a video mixer 110, an α blending portion 112, and a graphic display driver 114.

The main CPU 102 performs numerical computations, information processing, device control and the like and controls the various internal portions of the information processing device 100. The main CPU 102 is an example of an input portion and a user interface of the present invention. When the user of the video editing system 10 performs an input operation using, for example, the various input devices of the input unit 150, that is, the keyboard 151, the mouse 152, the controller 153, and the like, an operation signal that corresponds to the input operation arrives at the main CPU through a Universal Serial Bus (USB) interface, for example. The main CPU 102 then performs processing based on the operation signal that corresponds to the user's input operation. The main CPU 102 can also control the various internal portions of the information processing device 100 by outputting control signals to the various internal portions of the information processing device 100 in accordance with the processing.

The graphic processor 104 is an example of a screen display control portion, an icon display portion, and an icon moving portion and performs control that pertains to screen displays, mainly on the screen that is displayed on the display device 160 by the GUI. For example, if an input operation on the various input devices of the input unit 150 makes it necessary to change what is shown on the screen that is displayed on the display device 160 by the GUI, the graphic processor 104 receives a control signal from the main CPU, then generates and outputs the screen that is displayed on the display device 160. The screen image that is output from the graphic processor 104 is a progressive scan type of screen image with 1024 pixels horizontally and 768 pixels vertically. Note that in the present embodiment the main CPU 102 and the graphic processor 104 are connected by a PCI bus 116. Furthermore, in the present embodiment, the number of pixels on the screen that is generated and output by the graphic processor 104 is not limited to the current example.

The first memory 106 is connected to the main CPU 102 by a local bus 118 and is used to record data for the various types of processing that are performed by the main CPU 102. In the present embodiment, when, for example, the video signals are mixed in the video mixer 110, as described later, the video signals are recorded temporarily in the first memory 106, and the recorded data is then read out from the first memory 106.

The second memory 108 is connected to the graphic processor 104 by a local bus 120 and is used to record data for the various types of processing that are performed by the graphic processor 104.

The video mixer 110 mixes and outputs the video signals that are input to the information processing device 100. In the information processing device 100 according to the present embodiment, the video data before editing and the video data after editing can be displayed alongside one another on the display device 160. Therefore, the video signals for the video data before editing and the video signals for the video data after editing are mixed and output by the video mixer 110. The video mixer 110 may also be connected to the main CPU 102 through the local bus 118. Connecting the main CPU 102 and the video mixer 110 through the local bus 118 makes it possible to transmit the data at high speed. The main CPU 102 that is connected through the local bus 118 also performs image enlargement, image reduction, and position control with respect to the video signals. When the main CPU 102 performs image enlargement, image reduction, and position control with respect to the video signals, the video signals are temporarily recorded in the first memory 106, and the recorded data is then read out from the first memory 106, based on an internal synchronization of the information processing device 100.

In the present embodiment, the video signals that are input to the video mixer 110 are interlaced video signals with 1920 pixels horizontally and 1080 pixels vertically, and the video signals that are output from the video mixer 110 are progressive scan type video signals with 1024 pixels horizontally and 768 pixels vertically. Note that in the present embodiment, the number of pixels in the video signals that are input to the video mixer 110 and the number of pixels in the video signals that are output from the video mixer 110 are not limited to the current examples.

The α blending portion 112 performs an α blending of the screen image that is output from the graphic processor 104 with the video signals that are output from the video mixer 110, according to a specified ratio. Performing the α blending in the α blending portion 112 makes it possible for the GUI to display the results on the display device 160 without hindering the editing work. The α blending portion 112 may also be connected to the main CPU 102 through the local bus 118. Connecting the main CPU 102 and the α blending portion 112 through the local bus 118 makes it possible to transmit the data at high speed and to perform the α blending quickly.

The graphic display driver 114 accepts as input the video signals that are output from the α blending portion 112 and performs processing of the video signals to display the video on the display device 160. Performing the processing of the video signals in the graphic display driver 114 makes it possible to display the video properly on the display device 160.

The hardware configuration of the information processing device 100 according to the embodiment of the present invention has been explained using FIG. 3. Next, the screen that is displayed on the display device 160 by the GUI in the video editing system 10 according to the embodiment of the present invention will be explained.

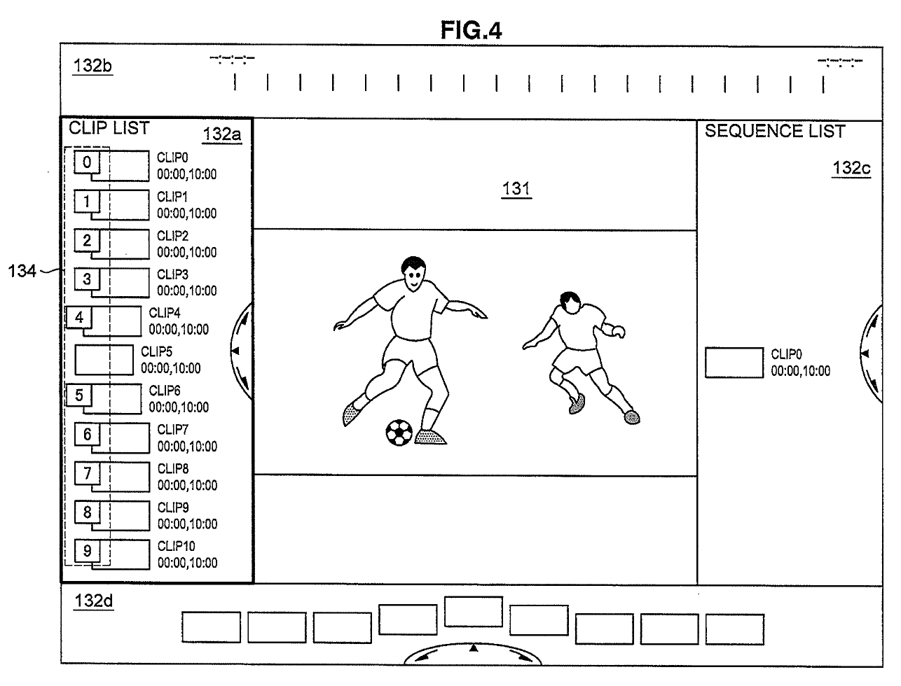

FIG. 4 is an explanatory figure that explains the screen that is displayed on the display device 160 by the GUI in the video editing system 10 according to the embodiment of the present invention. The screen that is shown in FIG. 4 is a screen that is displayed on the display device 160 when, for example, a screen that is generated by the graphic processor 104 through the GUI is mixed together in the video mixer 110 with the video signals that are input to the information processing device 100. The screen that is displayed on the display device 160 by the GUI will be explained below using FIG. 4.

As shown in FIG. 4, the screen that is displayed on the display device 160 in the video editing system 10 according to the embodiment of the present invention is configured such that it includes a main screen 131, as well as sub-screens 132a, 132b, 132c, and 132d that are displayed in a form that is superimposed on the main screen 131.

The main screen 131 is an area in which the video data is displayed that is based on the video signals that are input to the information processing device 100. In the present embodiment, the information processing device 100 can display and play back the unedited video and the edited video alongside one another on the main screen 131. Displaying and playing back the unedited video and the edited video alongside one another on the main screen 131 makes it possible for the user of the video editing system 10 to edit the video data efficiently.

The sub-screens 132a, 132b, 132c, and 132d are screens that are displayed superimposed on the main screen 131, and they each display various types of information for editing the video data.

The sub-screen 132a is an area in which unedited video data clips are displayed as still images in a thumbnail format. The thumbnail-format still images that are displayed on the sub-screen 132a are examples of objects according to the present invention. The video data clips that are displayed on the sub-screen 132a may be, for example, unedited video data clips that are recorded in a specified storage area in a storage medium such as a recorder or the like. The user can select one video data clip to be edited from among the video data clips that are displayed in the thumbnail format on the sub-screen 132a, and can perform video editing work on the selected video data clip.

The sub-screen 132b is an area in which is displayed a status of the video data clip that is selected on the sub-screen 132a. For example, the sub-screen 132b may display a current playback time and a total playback time for a video data clip that is being played back and displayed on the main screen 131. The sub-screen 132b may also display a time scale or the like for indicating a playback position, the time scale being an example of an object according to the present invention. When the video data clip that is selected on the sub-screen 132a is played back, the playback position of the video data clip can be determined by moving the time scale.

The sub-screen 132c is an area in which edited video data clips are displayed as still images in the thumbnail format. The thumbnail-format still images that are displayed on the sub-screen 132c are examples of objects according to the present invention. The video data clips that are displayed on the sub-screen 132c may be, for example, edited video data clips that are recorded in a specified storage area in a storage medium such as a recorder or the like. The user can select one video data clip to be edited from among the video data clips that are displayed in the thumbnail format on the sub-screen 132c, and can perform video editing work on the selected video data clip.

The sub-screen 132d is an area in which is displayed information for performing the editing work on the video data clip. The information that is displayed on the sub-screen 132d for performing the editing work on the video data clip may include, for example, information on the video data clip that is selected on the sub-screen 132a. The information that is displayed on the sub-screen 132d may also include a range of the video data clip that is selected on the sub-screen 132a, as indicated by an in point and an out point that are respectively designated by the Mark In button 153g and the Mark Out button 153h. A still image that is displayed on the sub-screen 132d in the thumbnail format is an example of an object according to the present invention. Displaying information of this sort on the sub-screen 132d makes it possible for the user to use the keyboard 151 and the mouse 152, and not just the controller 153, to perform the work of editing the video data clip.

As shown in FIG. 4, the screens that are displayed on the display device 160 include the four sub-screens 132a, 132b, 132c, and 132d. The user of the video editing system 10 can perform the editing work while looking at the main screen 131 and the sub-screens 132a, 132b, 132c, and 132d that are displayed on the display device 160.

Note that even in a case where a plurality of the sub-screens are displayed, only one of the sub-screens is an enabled sub-screen (an activated sub-screen) that can accept an operation. Accordingly, one feature of the present embodiment is that the user can easily tell which of the sub-screens is the activated one, because the graphic processor 104, for example, causes icons 134 to be displayed on the activated sub-screen in one-to-one relationships with the objects that are displayed on the activated sub-screen.

Note that the icons 134 according to the present embodiment are numbered 0 to 9 such that they can accept an operation by one of the ten-key pad 153j and a ten-key pad that is located on the keyboard 151. Note that according to the present invention, the form in which the icons 134 are displayed is obviously not limited to the current example. The icons 134 may also be identified by alphabetic characters such that they can accept an operation by a key that is located on the keyboard 151 apart from the ten-key pad (for example, one of a function key and an alphabetic character key). It is also obvious that the sizes and shapes of the icons 134 are not limited to those that are shown in FIG. 4. The number of the icons 134 is also not limited to the current example. The number of the icons 134 may be only one, and it may also be more than one.

There are also cases where the user of the video editing system 10 operates the various input devices of the input unit 150 to change which of the sub-screens is activated. One feature of the present embodiment is that when a change is made in which of the sub-screens is activated, the icons 134 are dynamically moved to the sub-screen that is newly activated in such a way that the user can track their movement to the newly activated sub-screen. There are also cases where the user of the video editing system 10 activates the main screen 131 by operating the various input devices of the input unit 150. One feature of the present embodiment is that in these cases, the icons 134 are not displayed, making it possible to determine that none of the sub-screens is activated. Control of the movement of the icons 134 and whether they are displayed or not displayed may be performed by the graphic processor 104, for example.

The screen that is displayed on the display device 160 by the GUI has been explained below using FIG. 4. Next, an information display method according to the embodiment of the present invention will be explained.

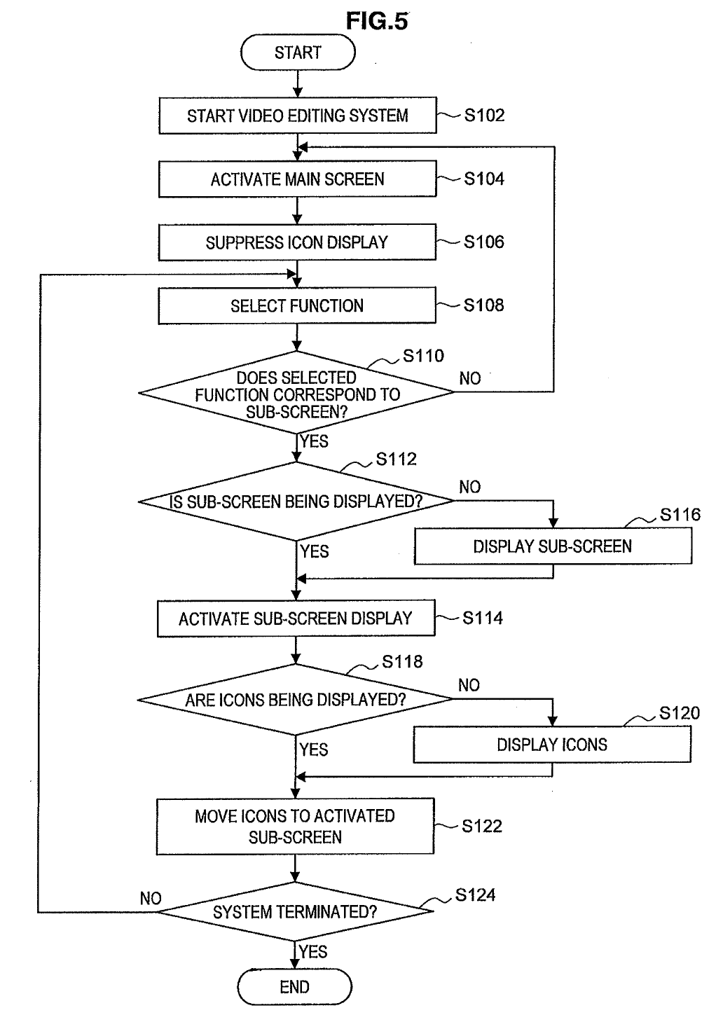

FIG. 5 is a flowchart that explains the information display method according to the embodiment of the present invention. The information display method according to the embodiment of the present invention will be explained in detail below using FIG. 5.

First, the video editing system 10 is started by the user of the system (Step S102). When the video editing system 10 is started, a screen like that shown in FIG. 4 is displayed on the display device 160. In the present embodiment, the main screen 131 is activated immediately after the video editing system 10 is started (Step S104). In the present embodiment, in a case where the main screen 131 is activated as just described, the icons 134 are not displayed. Therefore, the graphic processor 104 performs control such that the icons 134 are not moved to the screen that is displayed on the display device 160.

Next, the user of the video editing system 10 selects a function of the video editing system 10 (Step S108). The selection of the function may be performed, for example, by operating the various input devices of the input unit 150. To take one example, in a case where the user selects an unedited video to be worked on, the user presses the playback selection button 153d to perform the operation of selecting a video data clip that is recorded in a recorder or the like.

At Step S108, when the user of the video editing system 10 selects a function of the video editing system 10, a determination is made as to whether or not the selected function is associated with one of the four sub-screens 132a, 132b, 132c, and 132d (Step S110). For example, the sub-screen 132a is the area in which the unedited video data clips are displayed as still images in the thumbnail format, and the unedited video data clips can be selected by pressing the playback selection button 153d. Therefore, the function of selecting the unedited video data clips by pressing the playback selection button 153d can be said to be associated with the sub-screen 132a. Further, the sub-screen 132b is the area in which the status of the video data clip that is selected on the sub-screen 132a is displayed, and when the video data clip that is designated on the sub-screen 132a is played back, the time scale that is displayed on the sub-screen 132b moves to indicate the playback position. Therefore, the function of playing back the video data clip by pressing the Play button 153e can be said to be associated with the sub-screen 132b.

If the result of the determination at Step S110 is that the function that was selected by the user of the video editing system 10 is not associated with any of the four sub-screens 132a, 132b, 132c, and 132d, the processing returns to Step S104 and establishes a state in which the main screen 131 is activated. On the other hand, if the result of the determination at Step S110 is that the function that was selected by the user of the video editing system 10 is associated with one of the four sub-screens 132a, 132b, 132c, and 132d, a determination is made by the graphic processor 104 as to whether or not the associated sub-screen is being displayed on the display device 160 (Step S112).

If the result of the determination at Step S112 is that the sub-screen that is associated with the function that was selected by the user of the video editing system 10 is being displayed on the display device 160, the graphic processor 104 performs an activation of the display to indicate that the sub-screen is activated (Step S114). After the activation of the display is performed at Step S114, a determination is made as to whether or not the icons 134 are being displayed on the display device 160 (Step S118). If the icons 134 are not being displayed on the display device 160, the graphic processor 104 performs an operation to display the icons 134 (Step S120). If the icons 134 are already being displayed on the display device 160, Step S120 is skipped.

On the other hand, if the result of the determination at Step S112 is that the sub-screen that is associated with the function that was selected by the user of the video editing system 10 is not being displayed on the display device 160, the graphic processor 104 performs an operation to display the sub-screen on the display device 160 (Step S116). After the display of the sub-screen on the display device 160 is completed, the activation of the display is performed to indicate that the sub-screen is activated (Step S114). After the activation of the display is performed, the determination as to whether or not the icons 134 are being displayed on the display device 160 is made in the same manner as described above (Step S118). If the icons 134 are not being displayed on the display device 160, the graphic processor 104 performs the operation to display the icons 134 (Step S120).

Next, the graphic processor 104 performs control such that the icons 134 are displayed on the sub-screen that is associated with the function that was selected by the user of the video editing system 10 (Step S122). When the icons 134 are displayed on the sub-screen by the graphic processor 104 at Step S122, the graphic processor 104 performs control such that the icons 134 are dynamically moved to the sub-screen in such a way that the user can track their movement to the sub-screen.

For example, if the result of the determination at Step S118 as to whether or not the icons 134 are being displayed on the display device 160 is that the icons 134 are not being displayed on the display device 160, the graphic processor 104 performs the operation to display the icons 134 at Step S120. At Step S122, the graphic processor 104 takes the icons 134 that are displayed at Step S120 and displays them on the sub-screen that is associated with the function that was selected by the user of the video editing system 10. In this sequence, the display operation at Step S120 displays the icons 134 in the center portion of the main screen 131, and then the icons 134 are dynamically moved to the activated sub-screen.

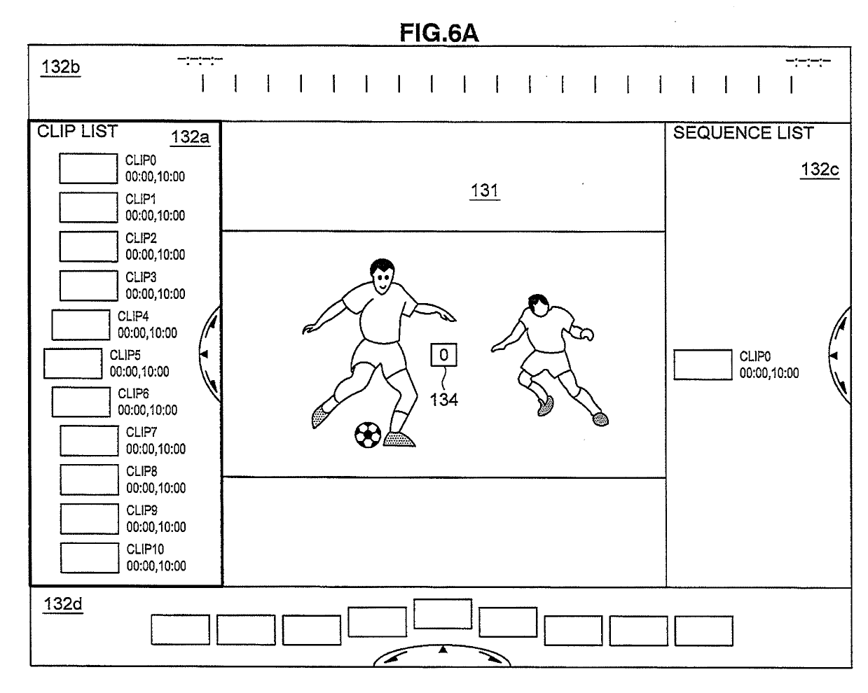

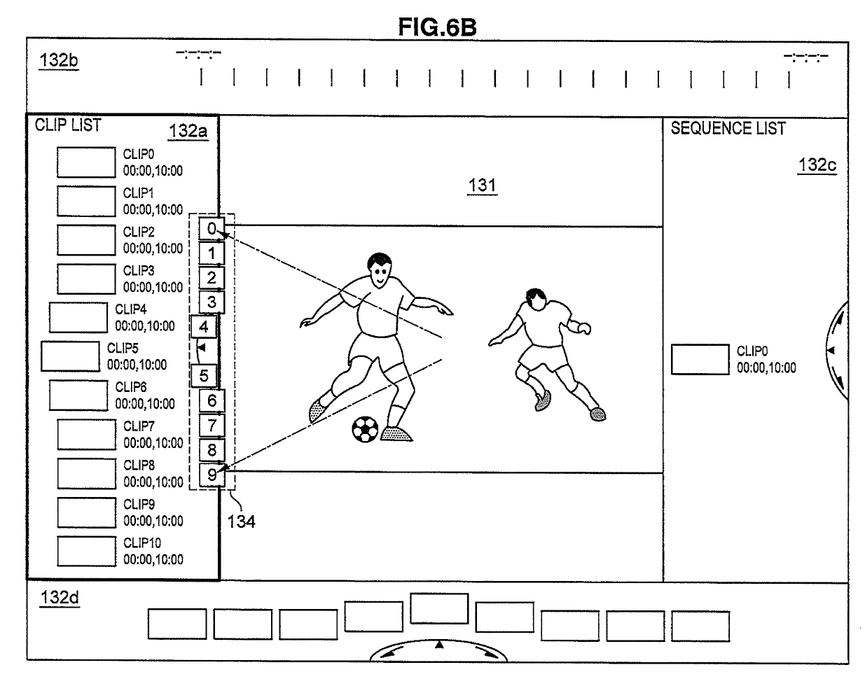

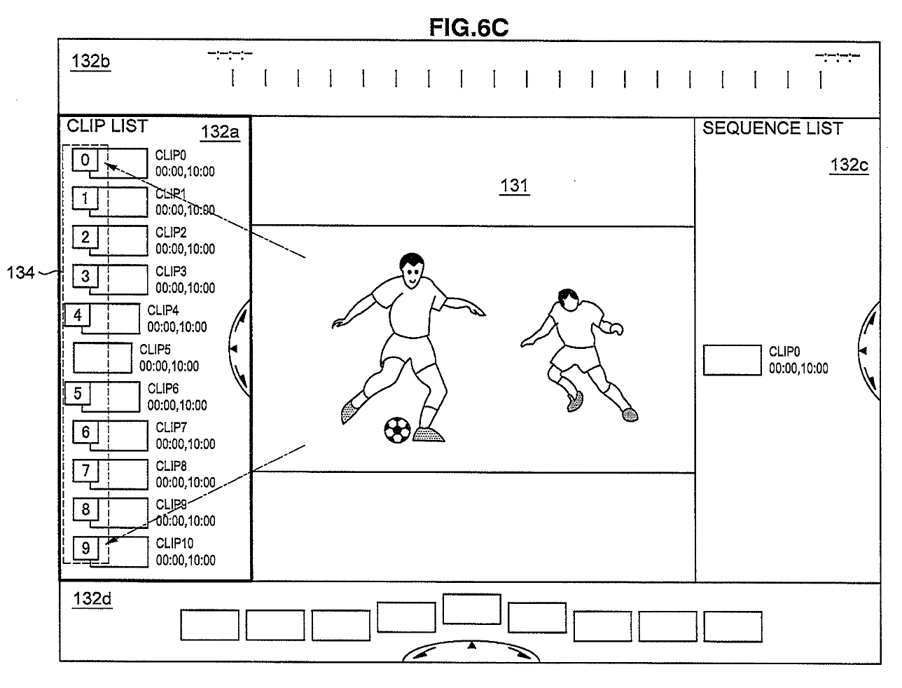

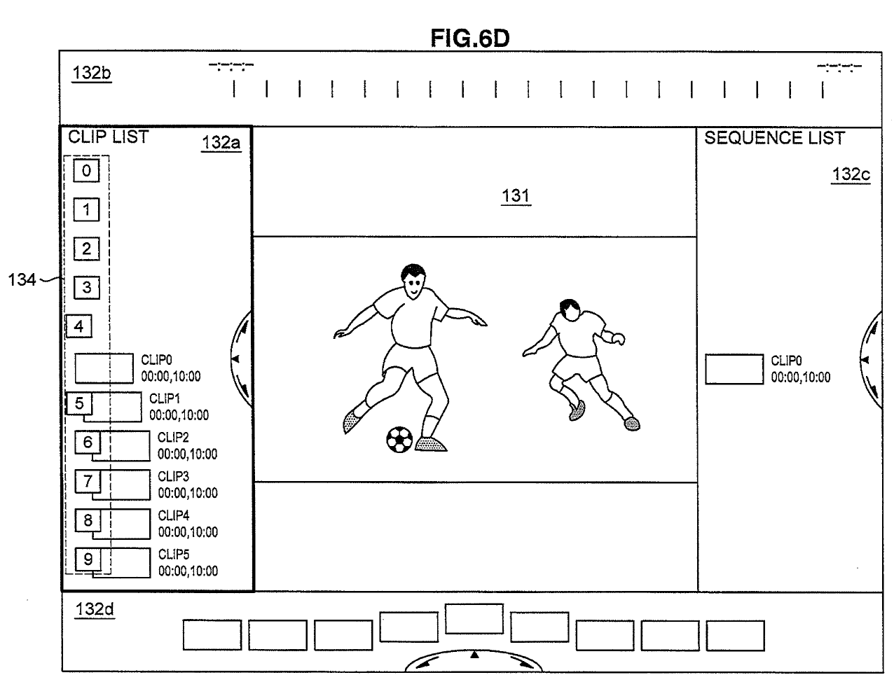

FIGS. 6A to 6C are explanatory figures that explain the operation of displaying and the operation of moving the icons 134 that are displayed on the display device 160. FIG. 6A shows an example of the screen that is displayed on the display device 160 when the icons 134 are being displayed in the center portion of the main screen 131 in a case where the result of the determination at Step S118 as to whether or not the icons 134 are being displayed on the display device 160 was that the icons 134 are not being displayed on the display device 160. FIG. 6B shows an example of the screen that is displayed on the display device 160 when the icons 134 are in the course of being moved toward the sub-screen 132a after the icons 134 have been displayed in the center portion of the main screen 131. FIG. 6C shows an example of the screen that is displayed on the display device 160 when the moving of the icons 134 to the sub-screen 132a has been completed.

As shown in FIGS. 6A to 6C, in a case where the icons 134 will be displayed on the sub-screen 132a, if the icons 134 are not already being displayed on the display device 160, the icons 134 are not directly displayed on the sub-screen 132a. First, as shown in FIG. 6A, at the same time that the icons 134 are displayed in the center portion of the main screen 131 for a moment, the sub-screen 132a is displayed in an accentuated manner such that the user will understand that the sub-screen 132a is activated. After the icons 134 are displayed in the center portion of the main screen 131 for a moment, the displayed icons 134 are dynamically moved to their destination within the sub-screen 132a in such a way that the user can track their movement, as shown in FIGS. 6B and 6C. In the present embodiment, the icons 134 are moved in such a way that all of the icons 134 arrive at their destination within the sub-screen 132a at the same time. Moving the icons 134 dynamically in such a way that the user can track their movement makes it easy for the user of the video editing system 10 to determine, by looking at the moving icons 134 on the display device 160, which function that corresponds to which sub-screen is enabled.

With the screen displayed on the display device 160 as shown in FIG. 6C, the user can operate the controller 153 to select one video data clip from among the unedited video data clips that are displayed in the thumbnail format on the sub-screen 132a. For example, with the screen displayed as shown in FIG. 6C, if the user presses any one of the number keys on the ten-key pad 153j, the main CPU 102 generates an operation signal that selects the unedited video data clip that corresponds to the number key that was pressed. The generating of the operation signal causes the unedited video data clip that corresponds to the number key to be selected. For example, if the user presses the 0 key on the ten-key pad 153j, the video data clips that are displayed on the sub-screen 132a are scrolled as shown in FIG. 6D, and the video data clip called “CLIP0” is changed to a selected status.

Note that when the icons 134 that are displayed on the display device 160 by the graphic processor 104 are dynamically moved, they may also be moved in a straight line from the center portion of the main screen 131 to their destination within the sub-screen 132a.

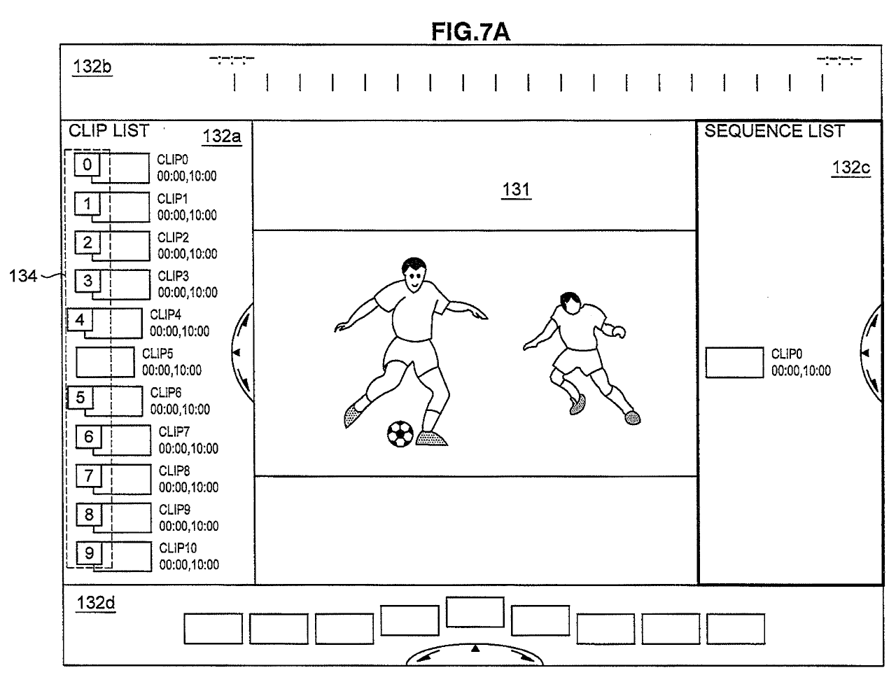

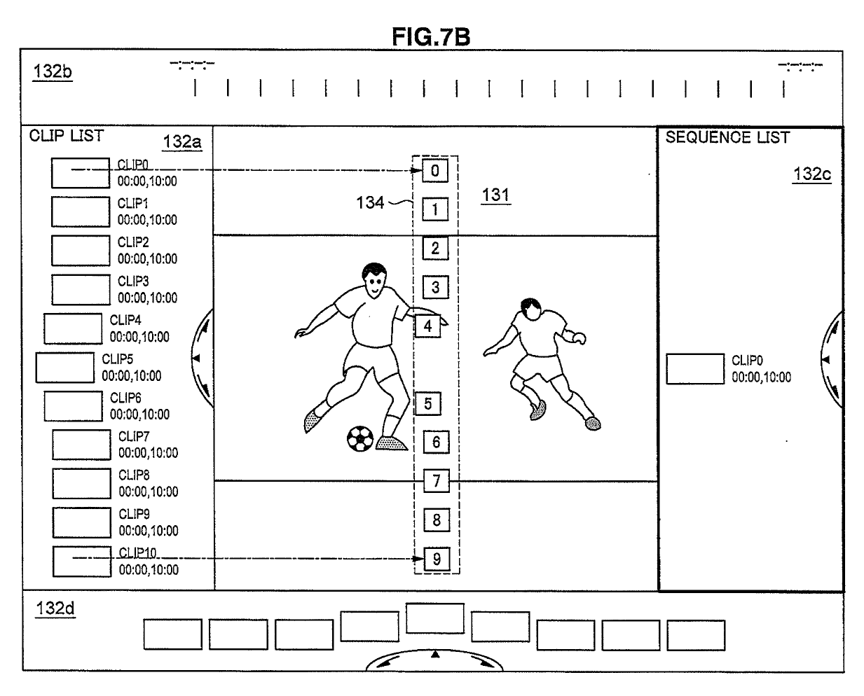

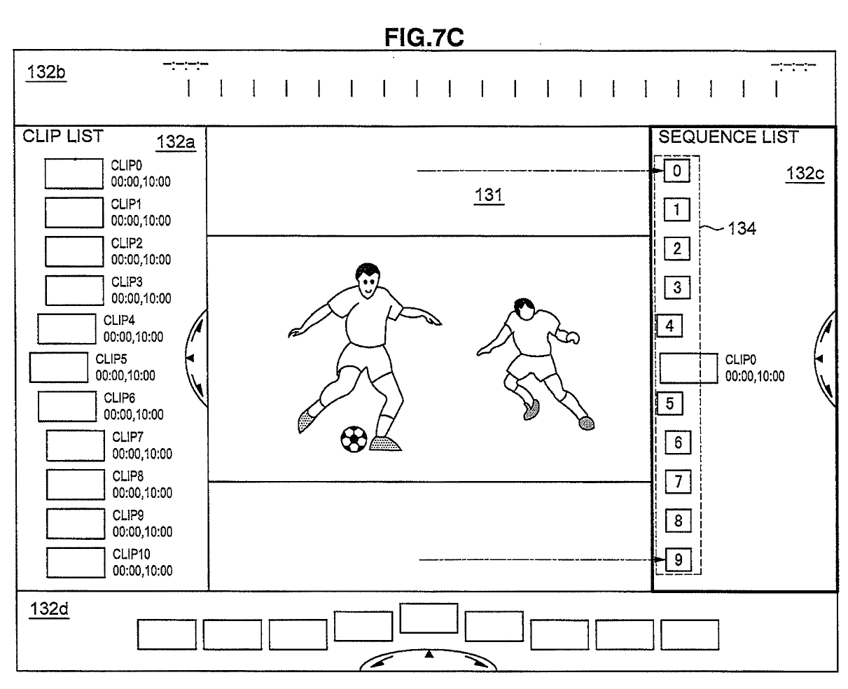

FIGS. 7A to 7C are explanatory figures that explain the operation of displaying and the operation of moving the icons 134 that are displayed on the display device 160. FIG. 7A shows an example of the screen that is displayed on the display device 160 when the icons 134 are being displayed on the sub-screen 132a in a case where the result of the determination at Step S118 as to whether or not the icons 134 are being displayed on the display device 160 was that the icons 134 are being displayed on the display device 160. FIG. 7B shows an example of the screen that is displayed on the display device 160 when the icons 134 are in the course of being moved from the sub-screen 132a to the sub-screen 132c. FIG. 7C shows an example of the screen that is displayed on the display device 160 when the moving of the icons 134 to the sub-screen 132c has been completed.

As shown in FIGS. 7A to 7C, in a case where the icons 134 will be displayed on the sub-screen 132c, if the icons 134 are already being displayed on the display device 160 (if the icons 134 are being displayed on the sub-screen 132a, as in the example shown in FIG. 7A), the icons 134 are not directly displayed on the sub-screen 132c. After the sub-screen 132a is displayed in an accentuated manner such that the user will understand that the sub-screen 132c is activated, the icons 134 are dynamically moved from the sub-screen 132a to the sub-screen 132d in such a way that the user can track their movement. In the present embodiment, the icons 134 are moved in such a way that all of the icons 134 arrive at their destination within the sub-screen 132c at the same time. Moving the icons 134 dynamically in such a way that the user can track their movement makes it easy for the user of the video editing system 10 to determine, by looking at the moving icons 134 on the display device 160, which function that corresponds to which sub-screen is enabled.

With the screen displayed on the display device 160 as shown in FIG. 7C, the user can operate the controller 153 to select one video data clip from among the edited video data clips that are displayed in the thumbnail format on the sub-screen 132c. However, in this case, no video data clips exist that correspond to the icons 134, so even if the user presses a key on the ten-key pad 153j, the state of the sub-screen 132c will not change.

Note that in this case as well, when the icons 134 that are displayed on the display device 160 by the graphic processor 104 are dynamically moved, they may also be moved in a straight line from the departure point on the sub-screen 132a to their destination within the sub-screen 132c.

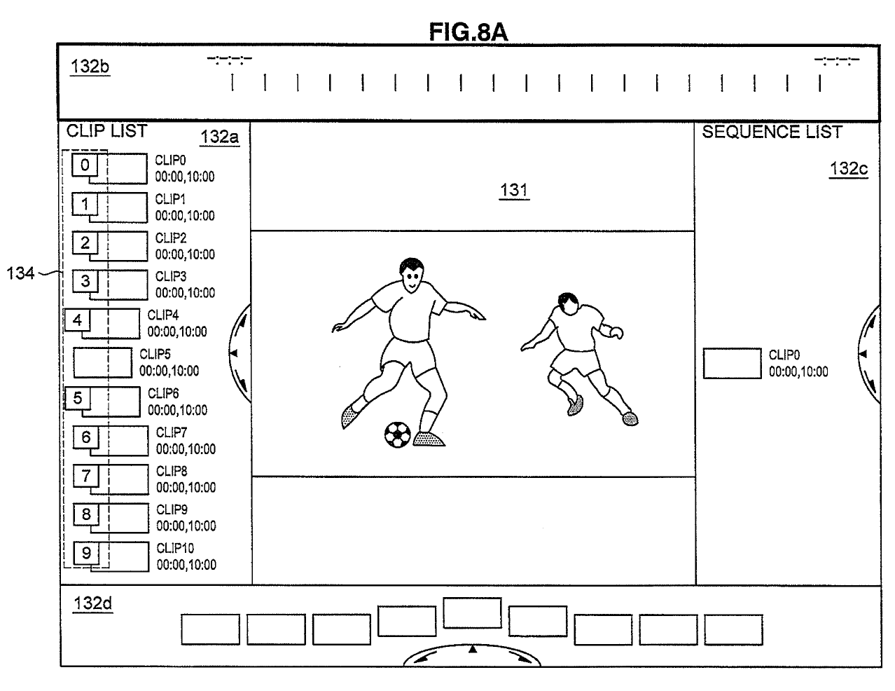

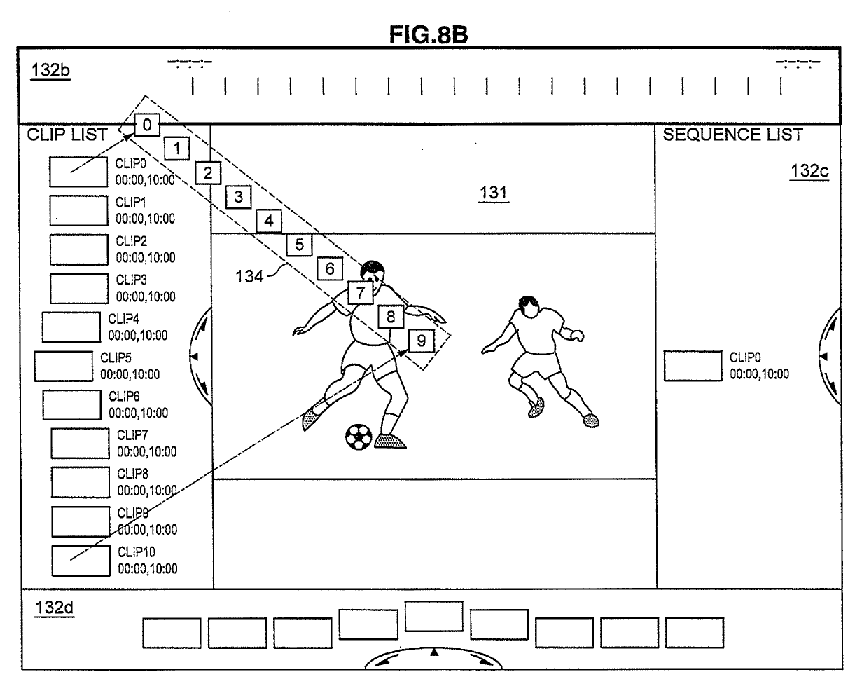

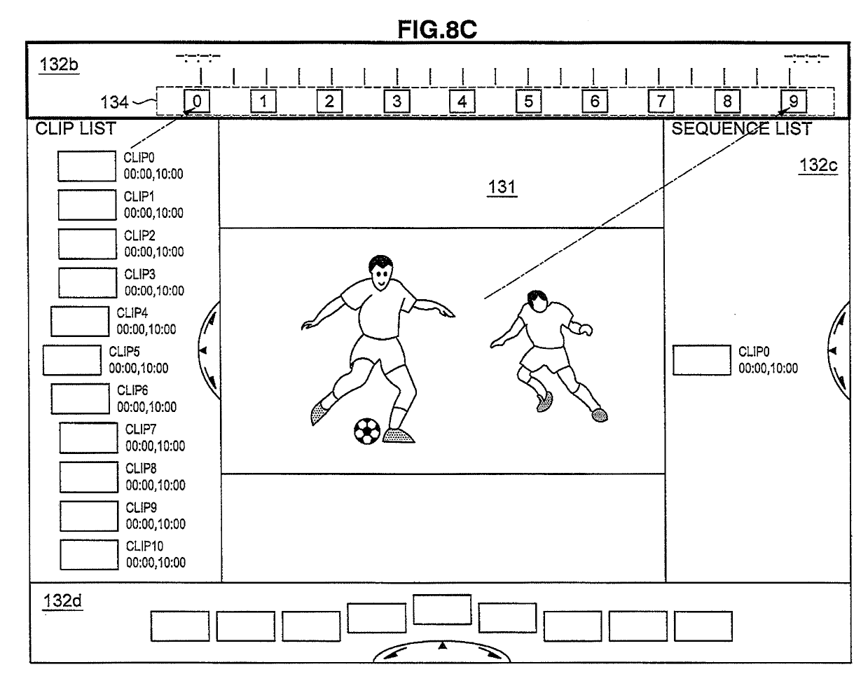

FIGS. 8A to 8C are explanatory figures that explain the operation of displaying and the operation of moving the icons 134 that are displayed on the display device 160. FIG. 8A shows an example of the screen that is displayed on the display device 160 when the icons 134 are being displayed on the sub-screen 132a in a case where the result of the determination at Step S118 as to whether or not the icons 134 are being displayed on the display device 160 was that the icons 134 are being displayed on the display device 160. FIG. 8B shows an example of the screen that is displayed on the display device 160 when the icons 134 are in the course of being moved from the sub-screen 132a to the sub-screen 132b. FIG. 8C shows an example of the screen that is displayed on the display device 160 when the moving of the icons 134 to the sub-screen 132b has been completed.

In a case where the icons 134 will be displayed on the sub-screen 132b, in the same manner as in the case shown in FIGS. 7A to 7C, the icons 134 are not directly displayed on the sub-screen 132c if the icons 134 are already being displayed on the display device 160 (if the icons 134 are being displayed on the sub-screen 132a, as in the example shown in FIG. 8A), even in a case where the icons 134 will be moved from the sub-screen 132a to the sub-screen 132b. After the sub-screen 132b is displayed in an accentuated manner such that the user will understand that the sub-screen 132b is activated, the icons 134 are dynamically moved from the sub-screen 132a to the sub-screen 132b in such a way that the user can track their movement. In the present embodiment, the icons 134 are moved in such a way that all of the icons 134 arrive at their destination within the sub-screen 132b at the same time. Moving the icons 134 dynamically in such a way that the user can track their movement makes it easy for the user of the video editing system 10 to determine, by looking at the moving icons 134 on the display device 160, which function that corresponds to which sub-screen is enabled.

With the screen displayed on the display device 160 as shown in FIG. 8C, the user can operate the controller 153 to control the playback of the video data clip that is currently being played back. For example, if the user presses a number key on the ten-key pad 153j, the graphic processor 104 moves the playback position on the time scale that is displayed on the sub-screen 132b to the position that corresponds to the number that was pressed. Moving the playback position on the time scale to the position that corresponds to the number that was pressed makes it possible to play back the video data clip starting at the designated position.

Note that in this case as well, when the icons 134 that are displayed on the display device 160 by the graphic processor 104 are dynamically moved, they may also be moved in a straight line from the departure point on the sub-screen 132a to their destination within the sub-screen 132b.

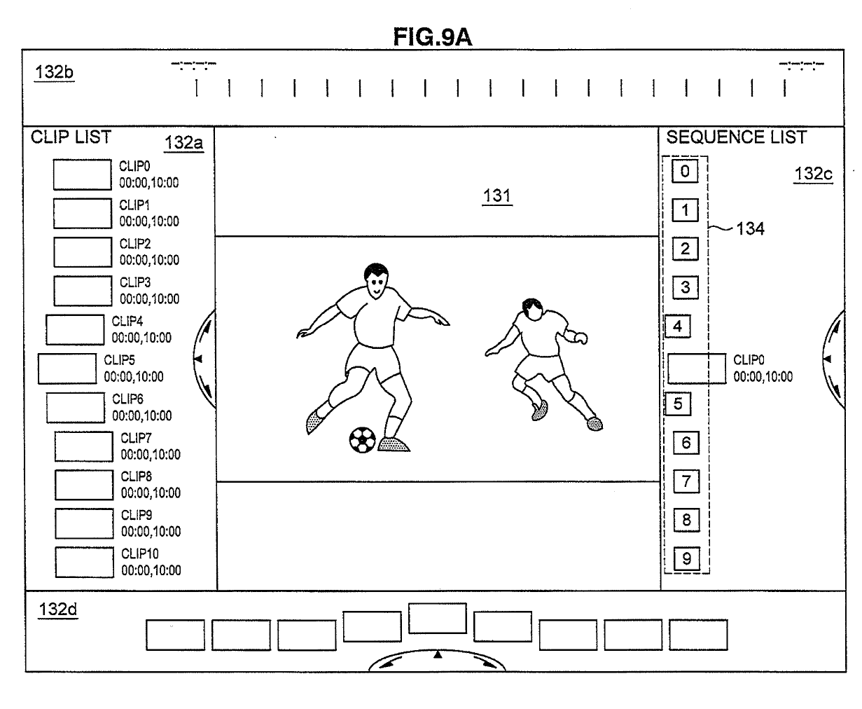

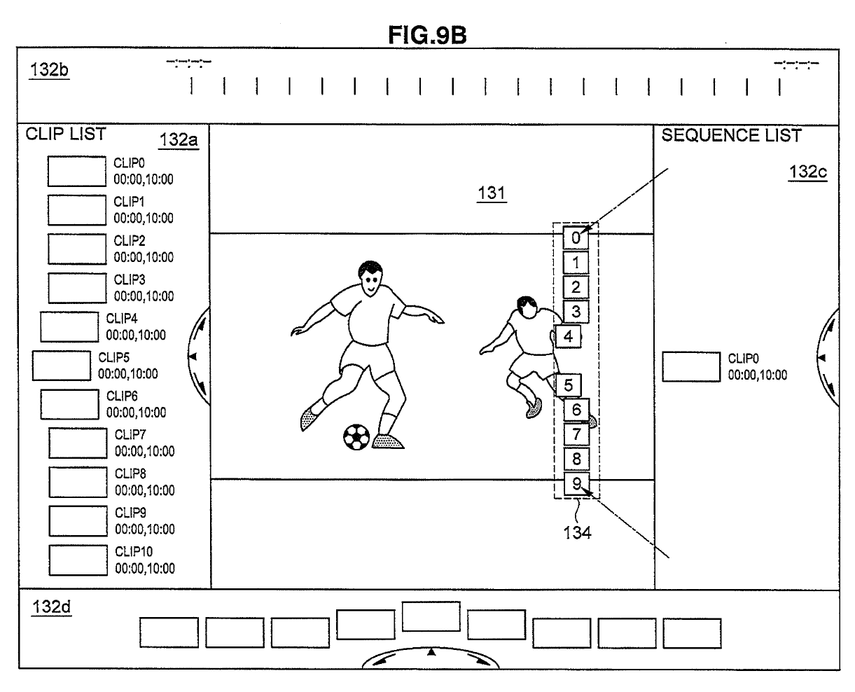

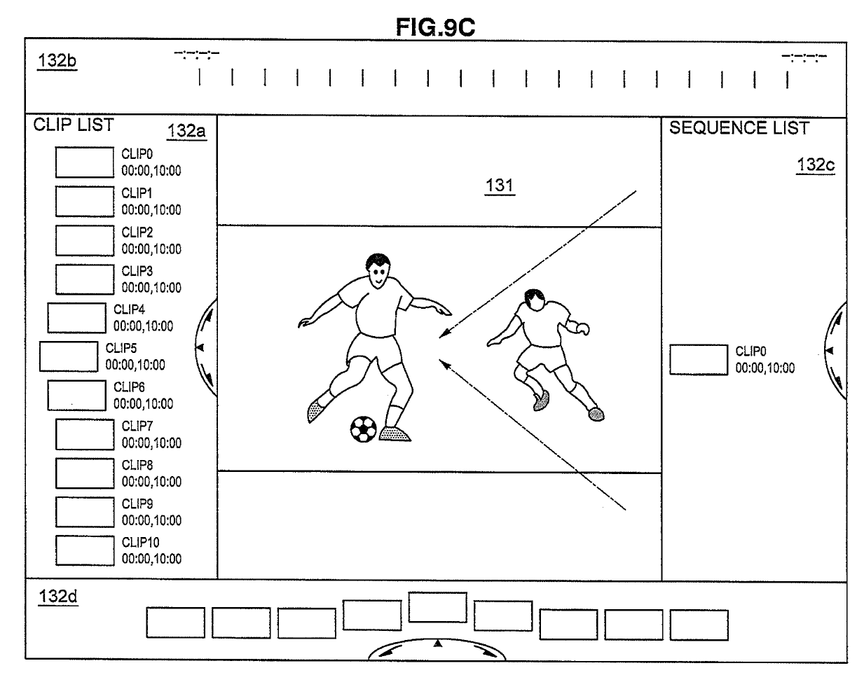

FIGS. 9A to 9C are explanatory figures that explain the operation of moving the icons 134 that are displayed on the display device 160. Unlike FIGS. 6A to 6C, FIGS. 7A to 7C, and FIGS. 8A to 8C, FIGS. 9A to 9C show the operation of moving the icons 134 in a case where the function that the user has selected is a function that does not correspond to any of the sub-screens, so that the icons 134 are erased from the screen.

FIG. 9A shows an example of the screen that is displayed on the display device 160 when the icons 134 are being displayed on the sub-screen 132c in a case where the result of the determination at Step S118 as to whether or not the icons 134 are being displayed on the display device 160 was that the icons 134 are being displayed on the display device 160. FIG. 9B shows an example of the screen that is displayed on the display device 160 when the icons 134 are in the course of being moved from the sub-screen 132c to the center portion of the main screen 131. FIG. 9C shows an example of the screen that is displayed on the display device 160 when the moving of the icons 134 to the center portion of the main screen 131 has been completed and the icons 134 have been erased from the screen.

Thus, in a case where the function that the user has selected is a function that does not correspond to any of the sub-screens, the icons 134 are dynamically moved in such a way that the user can track their movement, and the icons 134 are erased. This makes it easy for the user of the video editing system 10 to determine that none of the functions that correspond to the sub-screens are enabled.

Note that the examples that are shown in FIGS. 6A to 9C are obviously nothing more than examples of the operation of moving the icons 134. According to the present invention, the operation of moving the icons 134 may also be controlled such that it has various sorts of patterns other than those shown in FIGS. 6A to 9C.

For example, in the examples that are shown in FIGS. 6A to 9C, the icons 134 all arrive at their destination at the same time, but the present invention is not limited to this example. For example, the icons 134 may also be moved such that they arrive at the destination at different times. Even if the icons 134 are moved such that they arrive at the destination at different times, it is still easy for the user to determine which screen is enabled to accept an operation input. Further, in the examples that are shown in FIGS. 6A to 9C, the icons 134 all start to move at the same time, but the present invention is not limited to this example. For example, the icons 134 may also be controlled such that they start to move at different times.

Thereafter, a determination is made as to whether the video editing system 10 has been terminated by the user (Step S124). If the video editing system 10 has not been terminated, the processing returns to Step S108 and accepts the selection of a function by the user. On the other hand, if the video editing system 10 has been terminated, the processing ends.

The information display method according to the embodiment of the present invention has been explained using FIG. 5. Note that in the information display method according to the embodiment of the present invention, the operation of moving the icons 134 may start moving all of the icons 134 at the same time and may also move the icons 134 such that they all arrive at the destination at the same time. Note also that when the icons 134 are moved, they may be moved such that the speed of the movement becomes slower as the icons 134 move nearer to the destination (one of one of the sub-screens and the center portion of the main screen 131), and they may also be moved such that the speed of the movement remains constant.

According to the video editing system 10 and the information display method according to the embodiment of the present invention, as explained above, the icons that that are displayed on the screen correspond to the objects that are displayed on the screen. In response to an operation input from the user, the activation of the sub-screens is switched, the display is switched accordingly, and the icons 134 are dynamically moved to their destination within the activated sub-screen. Dynamically moving the icons 134 to their destination in this manner makes it easy for the user of the video editing system 10 to determine which screen is enabled to accept an operation input from the user.

Note that the various processes described above may also be performed by having one of the main CPU 102 and the graphic processor 104 sequentially read and execute a computer program that is stored in the information processing device 100. A computer-readable storage medium is also provided in which the computer program is stored. The storage medium may be, for example, a magnetic disk, a magneto optical disk, or the like.

It should be understood by those skilled in the art that various modifications, combinations, sub-combinations and alterations may occur depending on design requirements and other factors insofar as they are within the scope of the appended claims or the equivalents thereof.

For example, in the embodiment described above, the icons 134 are moved in a straight line from a start point to an end point, but the present invention is not limited to this example. For example, the icons 134 may also be moved in a curving line and through the center portion of the screen. Furthermore, in a case where a plurality of the icons 134 is displayed, the icons may be moved to their destination after all of the icons 134 are first clustered in the center portion of the screen.

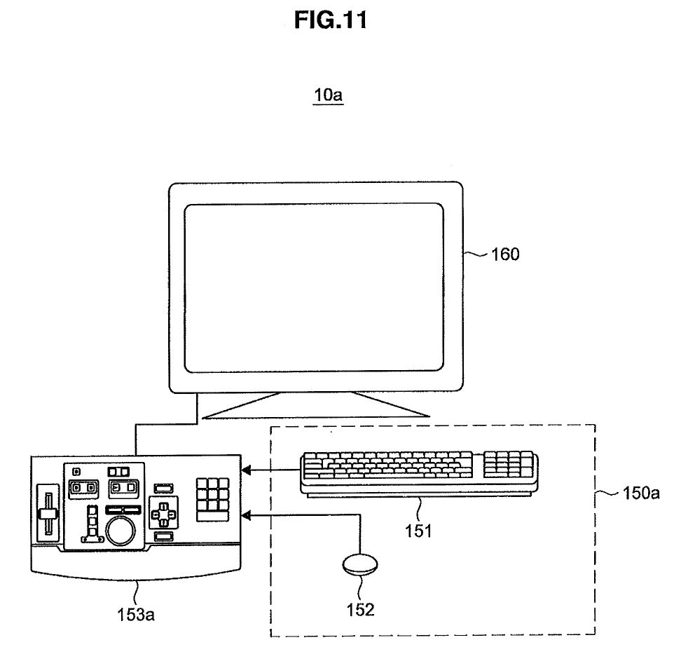

Also, in the embodiment described above, an example was explained of a case in which the information processing device 100 and the controller 153 are separate units, but the present invention is not limited to this example. FIG. 11 is an explanatory figure that shows a configuration of a video editing system 10a that is a modified example of the video editing system 10 according to the embodiment of the present invention. For example, as shown in FIG. 11, a controller 153a may operate such that it includes the functions of the information processing device 100 according to the embodiment of the present invention, and the information may also be displayed on the display device 160. Note that an input unit 150a that includes the keyboard 151, the mouse 152, and the like may also be connected to the controller 153a, and the user may edit the video data by operating the input unit 150a.

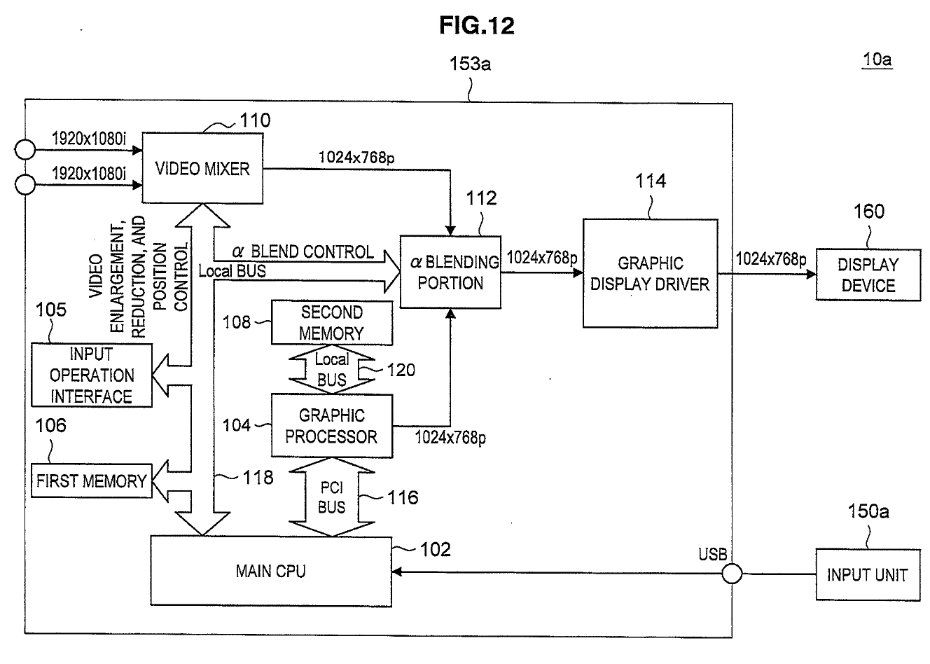

FIG. 12 is an explanatory figure that explains a hardware configuration of the controller 153a that is used in the video editing system 10a described above. In contrast to the hardware configuration of the information processing device 100 according to the embodiment of the present invention that is shown in FIG. 3, the controller 153a, as shown in FIG. 12, is configured such that it also includes an input operation interface 105 that accepts an input operation from the keyboard 151, the mouse 152, and the like. Note that in FIG. 12, a signal from the input unit 150a is sent to the main CPU 102 through the USB interface, but the signal from the input unit 150a may also be sent to the main CPU 102 through the input operation interface 105.

What is claimed is:

1. An information processing device, comprising:
a screen display control portion that controls a display of an area on a screen such that the area is able to accept an input operation by a user based on a display of an object on the screen and an operation signal that corresponds to the input operation by the user and that designates the area;
an icon display control portion that displays an icon that corresponds to the object that is displayed on the screen; and
an icon moving portion that moves the icon dynamically, based on the operation signal, to a target position within the area that is designated by the operation signal.

2. The information processing device according to claim 1, further comprising:
a user interface portion that, in accordance with the user input operation that corresponds to the icon, generates the operation signal such that the operation signal directly designates the object that corresponds to the designated icon.

3. The information processing device according to claim 1,
wherein the number of the icons is more than one, and
the icon moving portion causes all of the plurality of the icons to arrive at the target position at the same time.

4. The information processing device according to claim 1,
wherein the number of the icons is more than one, and
the icon moving portion moves the icons such that they arrive at the target position at different times.

5. The information processing device according to claim 1,
wherein the icon moving portion performs control such that the speed at which the icon moves becomes slower to the extent that the icon moves closer to the target position.

6. The information processing device according to claim 1,
wherein the icon moving portion moves the icon to the target position in a straight line.

7. The information processing device according to claim 1,
wherein a numeral is associated with the icon.

8. The information processing device according to claim 1,
wherein the screen includes a plurality of areas, and
the screen display control portion, based on the operation signal, switches the area that is able to accept the input operation by the user and switches the display accordingly, and
the icon moving portion moves the icon dynamically to a target position within the area that the screen display control portion has made able to accept the input operation by the user.

9. An information display method, comprising the steps of:
controlling a display of an area on a screen such that the area is able to accept an input operation by a user based on a display of an object on the screen and an operation signal that corresponds to the input operation by the user and that designates the area;
displaying an icon that corresponds to the object that is displayed on the screen; and
moving the icon dynamically, based on the operation signal, to a target position within the area that is designated by the operation signal.

10. A computer program comprising instructions that command a computer to perform the steps of:
controlling a display of an area on a screen such that the area is able to accept an input operation by a user based on a display of an object on the screen and an operation signal that corresponds to the input operation by the user and that designates the area;
displaying an icon that corresponds to the object that is displayed on the screen; and
moving the icon dynamically, based on the operation signal, to a target position within the area that is designated by the operation signal.
